(19) United States
(12) Patent Application Publication
(10) Pub. No.: US 2026/0144192 A1
(43) Pub. Date: May 28, 2026

(54) POWERED POLE TOOL

(71) Applicant: JAMESON, LLC, Clover, SC (US)

(72) Inventors: Carlos Fernando Becerra Alvarado, Charlotte, NC (US); Blake Andrew Tomlinson, Statesville, NC (US)

(21) Appl. No.: 19/398,894

(22) Filed: Nov. 24, 2025

Related U.S. Application Data
(60) Provisional application No. 63/723,977, filed on Nov. 22, 2024.

(51) Int. Cl. A01G 3/033; A01G 3/037; B25F 5/02

(52) U.S. Cl. CPC A01G 3/0335; A01G 3/037; B25F 5/02

(57) ABSTRACT

A pole tool includes a motor assembly and a tool assembly electrically isolated from the motor assembly. The motor assembly includes a first housing, an outer pole irrotationally connected to and extending longitudinally from the first housing, a motor within the first housing, and a drive column rotationally coupled to the motor and extending from the first housing at least partially within the outer pole. The tool assembly includes a second housing, an inner pole irrotationally connected to and extending longitudinally from the second housing, a tool head mounted on the second housing, and a drive shaft rotationally coupled to the tool head and extending from the second housing at least partially within the inner pole.

### CROSS-REFERENCE TO RELATED APPLICATION

This application claims the benefit of priority of U.S. provisional Ser. No. 63/723,977 titled “Powered Pole Tool,” filed on Nov. 22, 2024, which is incorporated herein in its entirety by this reference.

### TECHNICAL FIELD

The present disclosure relates to pole-mounted tools. More particularly, the present disclosure relates to a pole mounted pruner in which a motor assembly and tool are mounted on opposite ends of a length-adjustable electrically non-conducting pole assembly.

### BACKGROUND

A market niche exists for vegetation pruners mounted on the top ends of poles, such that branches that are elevated and out of reach to ground-level operators can be cut. The market offers a large variety of pruner styles and pole lengths and systems that can adapt to many user needs.

On the other hand, the development of newer technologies in electrical engineering has seen the proliferation of battery powered tools that utilize increasingly more powerful and efficient technologies such as new-generation batteries, electrical motors and electronic power and motion control systems. A few attempts have been made at combining all these so as to create a successful electric power pruner.

Pole-mounted pruners offer advantages over other cutting methods. For example, they produce a cleaner cut when compared to saws, which renders a healthier wound on the tree. They also cut faster than saws and require less effort. There are electric pole saws in the marketplace. Some are chain saws and some are disc saws but both have the inherent disadvantages of all saws as explained before. From a mechanical engineering point of view, chain saws have many more parts and are much more complicated machines than pruners. Saws, in general, are also more dangerous for some users.

There are a few pole-mounted electric pruners on the market, but they pack most of the mechanical components close to the cutting blade, at the top of the system, rendering them a high center of gravity, which makes them very difficult to maneuver.

There is a market need for clearing vegetation along or close to electrical power lines. This is dangerous work because power transmission and distribution conductors are not jacket-isolated, thus contact with the actual lines with conductive tools must be avoided. Tools that do not conduct electricity between the top (where the cutting blade is) and the bottom (where the operator is), have a tremendous value in terms of safety. They reduce/eliminate many hazards, such as user electrocution, arcing, spark generation (which could cause fires), etc.

Lastly, the height at which the cutting blade is needed varies due to a multitude of factors. However, there is a universal need for keeping the tool as short as possible during transportation. Therefore, a tool that can easily vary its length has additional value.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

A powered pole tool according to at least one embodiment includes a pole assembly having a proximal end and a distal end opposite the proximal end, a motor assembly mounted on the proximal end of the pole assembly, and a tool head mounted on the distal end of the pole assembly opposite the motor assembly. The pole assembly is constructed of non-electrically conductive material.

A pole tool according to at least one embodiment includes a motor assembly and a tool assembly electrically isolated from the motor assembly. The motor assembly includes a first housing, an outer pole irrotationally connected to and extending longitudinally from the first housing, a motor within the first housing, and a drive column rotationally coupled to the motor and extending from the first housing at least partially within the outer pole. The tool assembly includes a second housing, an inner pole irrotationally connected to and extending longitudinally from the second housing, a tool head mounted on the second housing, and a drive shaft rotationally coupled to the tool head and extending from the second housing at least partially within the inner pole.

The inner pole is irrotationally engaged with the outer pole thereby irrotationally coupling the second housing to the first housing.

The drive shaft is engaged with the drive column thereby operatively coupling the tool head to the motor.

The inner pole and drive shaft are together longitudinally adjustable relative to the outer pole and drive column.

In at least one example, the drive shaft is at least partially received by the motor interface drive column, the motor interface drive column is at least partially received by the inner pole, and the inner pole is at least partially received by the outer pole.

The outer pole and the inner pole together define a telescoping irrotational beam of variable length coupling the motor assembly and upper assembly at a variable adjustable distance.

In at least one example, the drive column and drive shaft are housed cooperatively by the outer pole and the inner pole. The drive column may be tubular and hollow and may include at least one longitudinally extending linear interior keyway slot. The drive shaft may include at least one outward longitudinally extending rail received by the at least one keyway slot.

In at least one example, the drive shaft is electrically non-conducting; the motor interface drive column is electrically non-conducting; and the inner pole is electrically non-conducting.

The drive shaft may include a longitudinally extending core shaft that is electrically non-conducting.

The tool head may define a pruner head.

In at least one example, the pruner head produces cutting action by movement of a blade against a fixed element.

The fixed element may be an anvil or blade.

The motor assembly may include an interface for connection to a power source.

The tool may include a battery configured for connection to the interface.

The above summary is to be understood as cumulative and inclusive. The above and below described features are to be understood as combined in whole or in part in various embodiments whether expressly described herein or implied by at least this reference. For brevity, not all features are expressly described and illustrated as combined with all other features. No combination of features shall be deemed unsupported for merely not appearing expressly in the drawings and descriptions.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1A is a side view of a powered pole pruner, according to at least one embodiment, in a telescopically collapsed condition.

FIG. 1B is a side view of the powered pole pruner of FIG. 1A in a telescopically extended condition, according to at least one embodiment.

FIG. 2 is a side view as in FIG. 1A, of the motor assembly of the of the powered pole pruner, according to at least one embodiment, with the irrotational outer pole shown in dashed line for illustration of the rotational motor interface drive column.

FIG. 3 is a side view as in FIG. 1A, of the tool assembly of the of the powered pole pruner, according to at least one embodiment, with the irrotational inner pole shown in dashed line for illustration of the rotational drive shaft.

FIG. 4 is an enlarged perspective view of a portion of the powered pole pruner of FIG. 1A for illustration of the non-rotational engagement of the upper and lower assemblies by way of the inner pole and outer pole.

FIG. 5 is an exploded perspective view of components of the motor assembly, according to at least one embodiment.

FIG. 6 is an exploded perspective view of components of the tool assembly, according to at least one embodiment.

FIG. 7 is an enlarged exploded side view of components of the tool head of the tool assembly, according to at least one embodiment.

FIG. 8 is an enlarged exploded perspective view of components of FIG. 7 taken from an opposite side thereof.

FIG. 9 is a perspective view of longitudinally sliding engagement features of the motor interface drive column of the upper assembly and the drive shaft 290 of the motor assembly.

FIG. 10 is a cross-section view showing the overlapping dispositions of longitudinally extending pole sections of the powered pole tool of FIG. 1A.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Any materials described are provided as non-limiting examples except where their inclusion is positively and unambiguously asserted. Once materials and arrangements are described herein with reference to any structures and elements thereof, for example in the drawings, such descriptions apply as well to any further same or similar structures and elements that may appear in other drawings.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

Unless defined otherwise, technical and scientific terms used herein have the same meaning as commonly understood to one of ordinary skill in the art to which the presently disclosed subject matter pertains.

This document presents a powered pole tool that includes many valuable features, including that the whole unit is lightweight, has a high cutting capacity, and provides speed and ease of operation. The powered pole tool is adaptable in terms of length or reach, and includes dielectric construction for added safety.

The powered pole tool has a pole assembly that can vary its length, with a motor assembly mounted on a user-proximal end of the pole assembly and tool assembly mounted on a distal end of the pole assembly opposite the motor assembly. The pole assembly is manufactured using non-electrically conductive material, thereby electrically isolating the user from any electrical hazards contacted by the tool head. The length of the pole assembly can be adjusted. In the illustrated embodiment, this is accomplished by extended or collapsing telescopic sections. In other embodiments, the pole assembly can be separated into shorter segments.

The pole assembly can be made, for example, from composite non-conductive materials. Examples of these materials include fiber reinforced composite to maintain electrically insulating properties across the pole sections, fiber reinforced polyamide and other non-electrically conductive materials. The material may be high strength to minimize cracks and stress and strain failures. The material may also be impact resistant and ultraviolet light resistant.

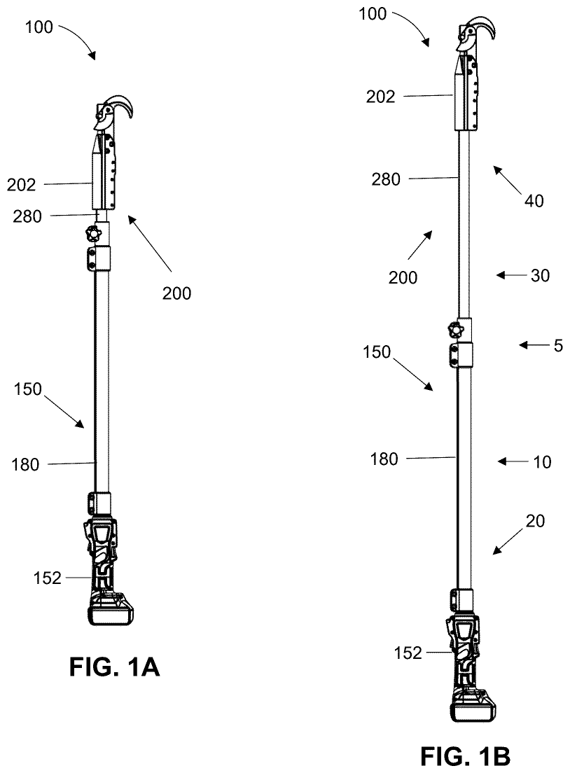

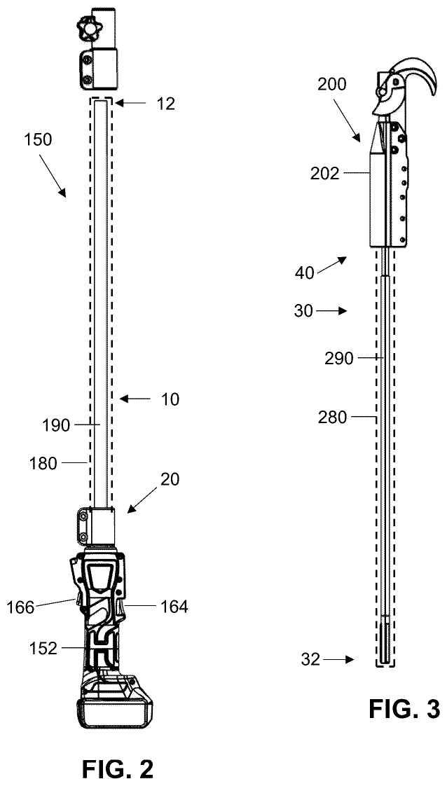

A powered pole tool 100 is illustrated in FIGS. 1A and 1B in different length configurations. The powered pole tool 100 includes an upper first assembly and a lower second assembly, referenced generally respectively as a motor assembly 150 and a tool assembly 200, which are respectively shown separately in FIGS. 2 and 3. The tool is likely to be generally wielded by a user by the motor assembly 150. Terms lower and upper are used herein for intuitive convention, referring respectively to user-proximal and user-distal features expecting a user to hold the motor assembly 150 as a handle and to guide use of the tool also grasping an outer pole 180 fixed to the motor assembly 150.

The upper assembly 200 carries an operable tool head at adjustable distances from the motor assembly 150. The upper assembly 200 and motor assembly 150 are coupled by an irrotational longitudinally sliding engagement of an outer pole 180 fixed to the motor assembly 150 and inner pole 280 fixed to the upper assembly 200. Respective housings of the upper assembly 200 and the motor assembly 150, and components irrotationally fixed thereto, are termed for descriptive convention herein as irrotational for distinction from rotating components by which the powered pole tool is operable.

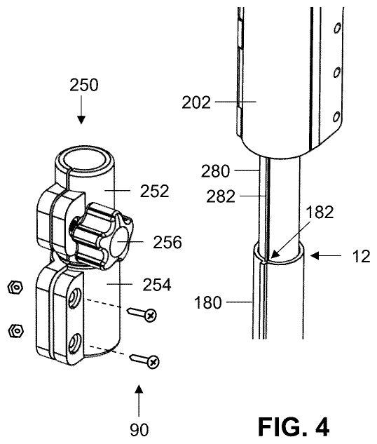

The irrotational outer pole 180 is tubular and hollow, and the irrotational inner pole 280 is received by the irrotational outer pole 180 in sliding engagement. As shown in FIG. 4, a longitudinally extending external rail 282 along the outer surface of the inner pole 280 is received by a corresponding longitudinally extending internal channel along the inner surface of the outer pole 180 preventing relative rotation of the housing of the upper assembly 200, referenced as the upper housing 202, and the housing of the motor assembly 150, referenced as the lower housing 152, while permitting the inner pole 280 and upper assembly 200 therewith to extend to various longitudinal positions. This enables use of the tool head carried by the upper assembly 200 at adjustable distances and heights from the motor assembly 150 grasped by the user. The inner pole 280 and outer pole 180 also have respective features that cooperatively prevent them from becoming completely separated from each other, so they limit how much the pole assembly can extend. The inner pole 280 and outer pole 180 are each tubular and hollow and are each electrically non-conductive thereby electrically isolating the upper assembly 200 from the motor assembly 150.

The inner pole 280 and outer pole 180 are maintained in their engagement at any chosen length by a poles joint 250. As shown in FIG. 4, the poles joint 250 includes fixed clamp section 254 which accepts nuts and bolts to provide its clamping action, and an adjustable clamp section 252 which accepts one hand-actuated knob 256 to perform its clamping action. The poles joint 250 is fixedly joined to the distal end 12 of the outer pole 180 at the fixed clamp section 254, such that no relative movement between the two is possible. Poles joint 250 is also joined to the inner pole 280 at adjustable clamp section 252, such that rotational movement between the inner pole 280 and poles joint 250 is prevented but axial movement between the inner pole 280 and poles joint 250 is permitted by actuating the hand-actuated knob 256 to loosen the clamping action for axial adjustment and tighten when a user-preferred position is acquired.

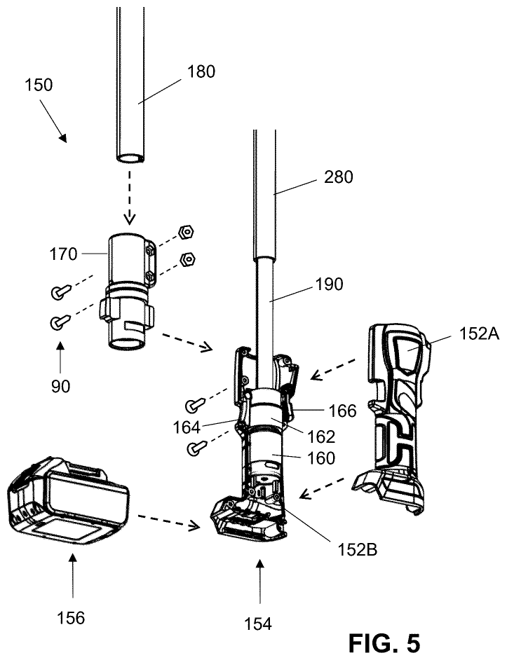

The motor assembly 150 is located at the bottom or user-proximal end of the powered pole tool 100. The motor assembly 150 includes the irrotational lower housing 152 made of electrically non-conductive material and designed to protect its contents against the elements. The lower housing 152 serves as both a frame ergonomically shaped for handling and as a protective enclosure, enclosing a motor 160 (FIG. 5) and a lower gear box 162 coupled together to direct and multiply the movement created by the motor 160 such that the tool head at the distal end of the powered pole tool 100 can utilize the generated mechanical motion effectively. Electronic control circuitry is also internally mounted and enclosed, and an operable user interface including a pivoting trigger switch 164 carried by the lower housing 152. The lower housing 152 may be, for example, molded from durable plastic and may be overmolded with sections or a layer of grippy polymer for secure and certain handling. Side portions 152A and 152B of the lower housing 152 are shown displaced for illustration of internal components.

The user-proximal lower housing 152 also incorporates an interface 154 that enables connection to a power source. Depending on specific embodiments and uses, the power source can be embodied as a snap-on rechargeable battery 156 as shown disengaged in FIG. 5, a remote battery (such as one to be carried as a backpack by the user), or a simple power cord to connect the device directly to an AC outlet.

The motor assembly 150 includes a motor interface drive column 190 that rotates relative to the lower housing 152 of the motor assembly 150. The lower end of the motor interface drive column 190 is coupled to and driven by the lower gear box 162, when the motor 160 is activated. The motor interface drive column 190 extends toward the upper assembly 200, from the lower housing 152 within the outer pole 180, and rotates within the irrotational outer pole 180 to provide mechanical energy for operation of the tool head. A lower pole mount 170 fixes the outer pole 180 to the lower housing 152 with neither rotational nor longitudinal movement of these three components being permitted upon assembly when the side portions of the housing 152 are assembled. In this embodiment, fasteners 90 illustrated as bolt and nut sets in FIG. 5 are shown directed to corresponding fastening holes in the components illustrated representative of how the motor assembly 150 is assembled and secured.

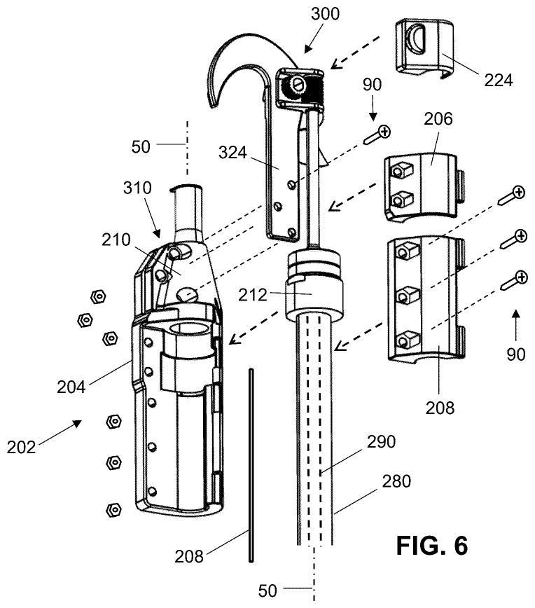

The upper assembly 200 is located at the top or user-distal end of the powered pole tool 100. The upper assembly 200 includes the upper housing 202, which is made of electrically non-conductive material and is designed to protect its contents against the elements. The irrotational upper housing 202 has a rigid base 204 (FIG. 6) that serves as both a frame and as a protective enclosure, fixing and enclosing an upper gear box and connecting the operable tool head to the irrotational inner pole 280. The upper housing 202 includes an inner pole top clasp 208 and a gear box clasp 206 each of which is pivotally connected to the base by a hinge pin 208 upon assembly and is secured into clasping positions in relation to the base 204 by fasteners 90 shown as bolt and nut sets. Once the fasteners 90 are tightened, the inner pole top clasp 208 is secured against rigid base 204, trapping the inner pole 280 inside and fixing it rotationally and axially with respect to upper housing 202. The gear box clasp 206 similarly fixes the upper gear box 212 and rigid base 204 together.

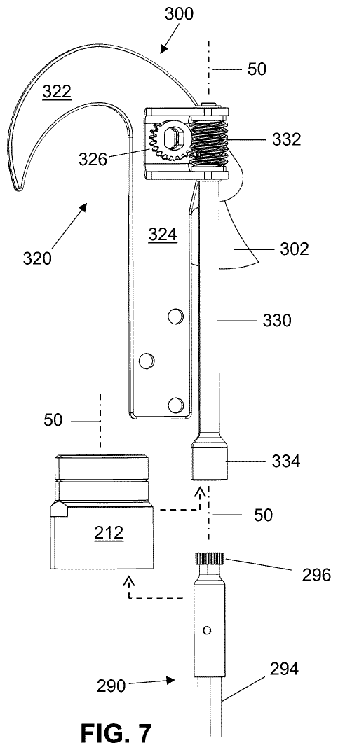

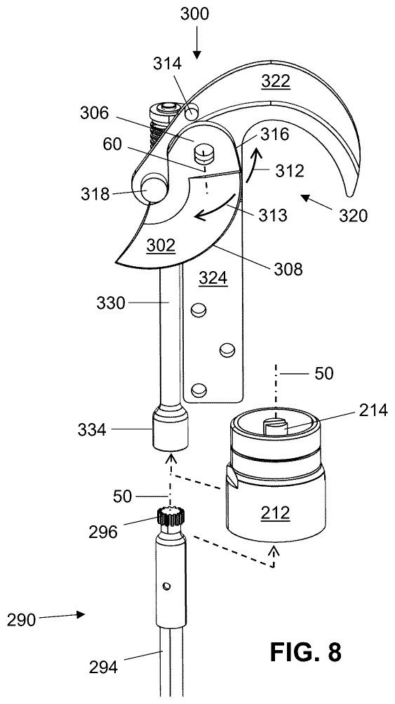

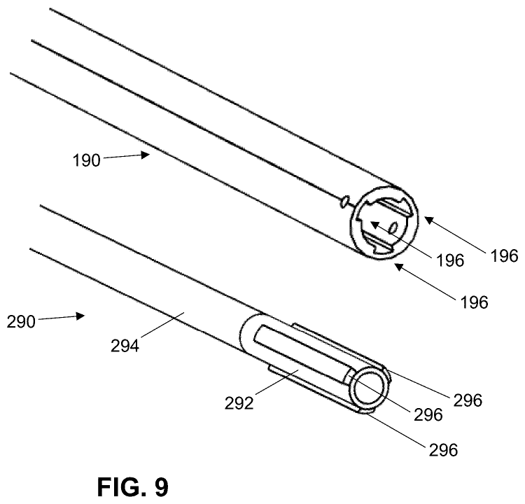

The upper assembly 200 includes a drive shaft 290 that extends from the upper housing 202 toward the motor assembly 150. The drive shaft 290 has a lower sliding connector 292 (FIG. 9) and upper spur gear 296 (FIG. 7-8) connected together by a longitudinally extending core shaft 294. The drive shaft 290, via the sliding connector 292, is engaged and turned at its lower end by the motor interface drive column 190, which rotates relative to the lower housing 152 within the irrotational outer pole 180. The upper gear box 212, at its lower input end, is engaged by a spur gear 296 fixedly mounted on the upper terminus of the drive shaft 290, and is thus mechanically powered by the drive shaft 290. Rotational mechanical energy is conveyed by the upper gear box from the lower input end thereof to the upper output end thereof, illustrated in FIG. 8 as having a slotted rotational output post 214. The upper gear box 212, in at least one embodiment, internally includes an internal planetary gearset that converts the rotational movement of the rotating driveshaft from high-speed and low-torque rotation to low-speed and high-torque rotation.

The upper assembly 200 includes an operable tool head 300 carried by the upper housing 202 in its function as a rigid frame. The tool head 300 of the drawings is shown as a pruner head in the illustrated embodiment. At the working end of the tool head 300, a pruning blade 302 rotates partially around a transverse axis 60 relative to a fixed element 320 to sever material placed or trapped therebetween in use. The fixed element 320 has a hooked anvil 322 in the illustrated embodiment. The blade 302 has a pivoting mount 306 and a curved cutting edge 308, which rotates into the gap of the hooked anvil 322 to execute a cut in by-pass style. Other embodiments may include anvil-style cutting, two-blade shear style cutting, and other severing arrangements.

In the illustrated embodiment, the fixed element 320 has a flat shank 324 connected to the hooked anvil 322. The fixed element 320 is irrotationally connected by placement of the shank 324 into a slot 310 defined by the upper housing 202 and secured by fasteners 90 (FIG. 6) shown as bolt and nut sets, engaging aligned respective holes through the shank and rigid base 204 of the upper housing 202. The blade is pivotally mounted on the shank.

The final rotational drive action at the blade (FIG. 7) is provided by a spur gear 326 fixed to the blade 322 and a drive pin 330 having a worm gear 332 at its upper end engaging the partial spur gear 326. The drive pin 330 and worm gear 332 therewith turn on a longitudinal axis 50. The worm gear 332 turning with the drive pin 330, and the spur gear 326 connected to the blade 302, mutually engage and cooperatively convert the rotational movement from the drive pin about axis 50 to rotational movement of the blade about axis 60. This conversion includes a change of axis, a speed reduction, and a torque increase. A worm gear housing 224 (FIG. 6) covers the worm gear 332 and spur gear 326 preventing debris from entering their engagement area and provides a layer of electrical isolation. These working-end components may vary among embodiments of powered pole tools of which a pruner is a non-limiting example.

Rotational mechanical energy is conveyed from the upper gear box 212 by engagement of the lower end 334 of the drive pin 330 with the rotational output post 214 on upper gearbox 212, shown as slotted in this embodiment, but which could take other geometries in other embodiments. The lower end 334 of the drive pin 330 is illustrated as a socket that receives and engages the output post 214, turning with the output post 214 upon rotation thereof. The drive pin 330 rotates within and is guided by the terminal ferrule 210 at the end of the upper housing 202 when the upper gear box 212 is driven by the drive shaft 290. The cutting action of the blade 302 occurs when it is rotated in a first angular direction 312 from its idle position (FIG. 8) until it reaches an end of travel position. The blade 302 stops its movement at its end of travel position due to a first mechanical hard stop 314 extending from the fixed element 320 and abutting a first blunt edge 316 of the mount 306 that leads when pivoting in the first angular direction 312.

At this point sensors in the electronic control system in housing 152 of the motor assembly 150 detect an increase in current drawn by the motor indicating the blade 302 has reached its end of travel position and reverses the motor 160. Other embodiments may use other end-of-travel detection methods instead of or in addition to current spike detection, such as revolutions counting. This reverses rotation of the blade 302 into a second angular direction 313, opposite the first angular direction 312 (FIG. 8). The blade 302 will then rotate until it reaches its idle position again. The motor again stops its movement when the blade 302 reaches its idle position (FIG. 8) because of a second mechanical hard stop 318 extending from the fixed element 320, which abuts a second blunt edge of the blade 302 opposite the cutting edge 308 as illustrated. This triggers the electronic control system to stop the motor in a manner as described with reference to the end of travel position.

The motor 160 will rotate in its direction corresponding to the cutting first angular direction 312 of the blade 302 only for as long as the trigger switch 164 located on the motor housing is pressed and until the end of travel position is reached. The motor assembly 150 also includes a forced reverse button 166 that when pressed will engage the motor to counter-rotate such that the blade 302 rotates in its second angular direction 313 to return same to its idle position (FIG. 8), which may be necessary if the blade becomes stuck before it reaches the end of travel position.

The motor interface drive column 190 extending from the motor assembly 150 and rotating within the irrotational outer pole 180 delivers rotational mechanical energy to the upper assembly 200 by receiving and engaging the drive shaft 290 extending from the upper assembly 200 within the irrotational inner pole 280.

In the illustrated embodiment, the motor interface drive column 190 is tubular and hollow, having linear interior keyway slots 196 extending longitudinally to engage the drive shaft 290. A terminal lower end of the drive shaft 290 has a sliding connector with outward longitudinally extending rails 296 corresponding to and received by the keyway slots 196. Longitudinally sliding engagement of the sliding connector 292 with the interior of the motor interface drive column 190 by the rails 296 within the keyway slots 196 enforces same rotation of the drive shaft 290 and drive column 190 at any axial position of the sliding connector 292 within the drive column.

As with the inner pole 280 and outer pole 180, which are each electrically non-conductive thereby electrically isolating the upper assembly 200 from the motor assembly 150, the motor interface drive column 190 and drive shaft 290 are electrically non-conductive and thereby electrically isolate the upper assembly 200 from the motor assembly 150. For example, in at least one embodiment, the motor interface drive column 190 is entirely made of non-conductive material, and at least the core shaft 294 of the drive shaft 290 is made of non-conductive material.

The outer pole 180 and inner pole 280 together define a telescoping irrotational beam of variable length coupling the motor assembly 150 and upper assembly 200 at a variable adjustable distance. The mutually engaged motor interface drive column 190 and sliding connector 292, with a lower portion of the core shaft 294, are rotatably housed by the irrotational outer pole 180 and inner pole 280. The motor interface drive column 190 and sliding connector 292 together accommodate length adjustments of the powered pole tool 100 as the core shaft 294 and sliding connector 292 slide longitudinally within the motor interface drive column 190.

Accordingly, the motor interface drive column 190 can transmit rotational movement without rotational slippage to the sliding connector 292 by engagement of the rails 296 with the keyway slots 196. As the inner pole 280 slides within the outer pole 180, the sliding connector 292 slides within the motor interface drive column 190. The total length of the powered pole tool 100 can vary from a fully extended condition (FIG. 1B) to fully collapsed condition (FIG. 1A). The drawings are not necessarily drawn to scale, particularly with regard to the length of the powered pole tool in FIG. 1B, which can be much longer than the appearance of the drawings might otherwise infer.

The irrotational outer pole 180 and rotational motor interface drive column 190 are each longitudinally extending and are generally connected to and carried by the motor assembly 150. The upper assembly 200 is generally connected to and carried by each of the irrotational inner pole 280 and drive shaft 290, which are each longitudinally extending. These longitudinally extending components can as well be described as a longitudinally extendible pole assembly having diassembleable sections.

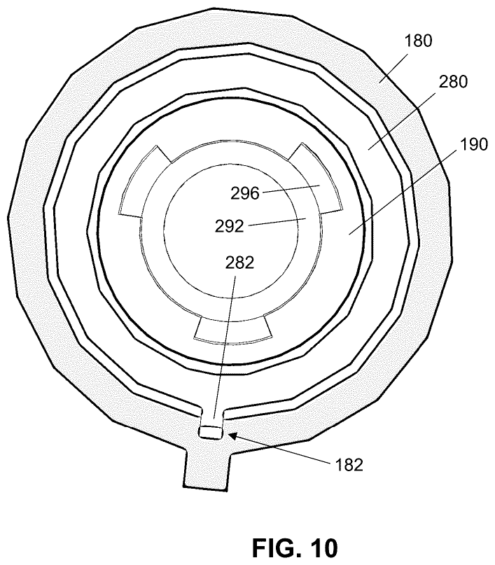

The pole assembly 5 (FIG. 1) can accordingly be described as including a first modular section 10 that includes the outer pole 180 and motor interface drive column 190, which are mounted at first ends thereof to a first mechanism 20 (FIG. 2) shown in the illustrated embodiment as the remaining lower portion of the motor assembly 150. The outer pole 180 serves as an outer sheath overlapping and surrounding the motor interface drive column 190 in mutual support. The pole assembly 5 includes a second modular section 30 that includes the inner pole 280 and drive shaft 290, which are mounted at first ends thereof to a second mechanism 40 shown in the illustrated embodiment as the remaining upper portion of the tool assembly 200. The outer pole 180 serves as an outer sheath overlapping and surrounding the drive shaft 290 in mutual support. Upon longitudinally-sliding engagement (FIG. 1B) of the second end 12 (FIG. 2) of the first section 10 with the second end 32 (FIG. 3) of the second section 30, opposite their respective coupling mechanisms (20, 40), the drive shaft 290 is received by the motor interface drive column 190, which is received by the inner pole 280, which is received by the outer pole 180 (FIG. 10), defining an overlapping longitudinally extending pole assembly with a respective mechanism at each opposite end thereof.

Accordingly, the pole assembly can find utility by providing, for those shown and other mechanisms than those shown expressly in the drawings, a supportive engagement with protected rotational engagement of internal components within irrotational poles with end-to-end length adjustability and electrical isolation.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A pole tool comprising:
a motor assembly comprising a first housing, an outer pole irrotationally connected to and extending longitudinally from the first housing, a motor within the first housing, and a drive column rotationally coupled to the motor and extending from the first housing at least partially within the outer pole; and
a tool assembly electrically isolated from the motor assembly, the tool assembly comprising a second housing, an inner pole irrotationally connected to and extending longitudinally from the second housing, a tool head mounted on the second housing, and a drive shaft rotationally coupled to the tool head and extending from the second housing at least partially within the inner pole;
wherein:
the inner pole is irrotationally engaged with the outer pole thereby irrotationally coupling the second housing to the first housing;
the drive shaft is engaged with the drive column thereby operatively coupling the tool head to the motor; and
the inner pole and drive shaft are together longitudinally adjustable relative to the outer pole and drive column.

2. The pole tool of claim 1, wherein:
the drive shaft is at least partially received by the motor interface drive column;
the motor interface drive column is at least partially received by the inner pole; and
the inner pole is at least partially received by the outer pole.

3. The powered pole tool of claim 2, wherein the outer pole and the inner pole together define a telescoping irrotational beam of variable length coupling the motor assembly and upper assembly at a variable adjustable distance.

4. The powered pole tool of claim 3, wherein the drive column and drive shaft are housed cooperatively by the outer pole and the inner pole.

5. The powered pole tool of claim 4, wherein:
the drive column is tubular and hollow and comprises at least one longitudinally extending linear interior keyway slot; and
the drive shaft comprises at least one outward longitudinally extending rail received by the at least one keyway slot.

6. The powered pole tool of claim 5, wherein the at least one outward longitudinally extending rail slides longitudinally within the at least one keyway slot upon the inner pole and drive shaft being together longitudinally adjusted relative to the outer pole and drive column.

7. The powered pole tool of claim 4, wherein the drive column comprises multiple longitudinally extending linear interior keyway slots; and the drive shaft comprises multiple outward longitudinally extending rails each received by a respective keyway slot.

8. The pole tool of claim 1, wherein:
the outer pole is electrically non-conducting;
the motor interface drive column is electrically non-conducting; and
the inner pole is electrically non-conducting.

9. The pole tool of claim 8, wherein the drive shaft comprises a longitudinally extending core shaft that is electrically non-conducting.

10. The powered pole tool of claim 1, wherein the tool head defines a pruner head.

11. The powered pole tool of claim 10, wherein the pruner head produces cutting action by movement of a blade against a fixed element.

12. The powered pole tool of claim 11, wherein the fixed element comprises an anvil or blade.

13. The powered pole tool of claim 1, wherein the motor assembly comprises an interface for connection to a power source.

14. The powered pole tool of claim 13, further comprising a battery configured for connection to the interface.
